(19) United States
(12) Patent Application Publication
(10) Pub. No.: US 2008/0021144 A1
(43) Pub. Date: Jan. 24, 2008

(54) Multi-colored texture paint

(76) Inventors: John Scott Stahlberg, Skokie, IL (US); Mark Richard Sadler, Hanover Park, IL (US)

Correspondence Address: Michael Murphy, 11 Hawthorn Parkway, Vernon Hills, IL, 60061, US

(21) Appl. No.: 11/489,681

(22) Filed: Jul. 20, 2006

(51) Int. Cl. C08K 3/26

(52) U.S. Cl. 524/425; 524/445; 524/451

(57) ABSTRACT

A paint product comprising: (a) polymer waxes such as polypropylene or polyethylene plastics which have been ground to particle sizes ranging from 44 microns to 840 microns, wherein said polymer waxes are of different sizes and/or different colors, except that they may not consist solely of black and/or white pigmented polymer waxes; and (b) suspending agents such as, but not limited to, organo clays, small particle size talcs, calcium carbonate and other inert pigments commonly used as suspending agents in paint compositions and the manufacture of such paint products.

### BACKGROUND OF INVENTION

This invention relates to paint compositions which utilize micro powder plastic to provide a multi-colored textured dry paint film. More particularly, the present invention relates to paint compositions which are suitable for brush on or aerosol spray application and which contain polymer waxes such as polypropylene or polyethylene plastics which have been ground to particle sizes ranging from 44 microns to 840 microns.

Black or white polypropylene and polyethylene plastics are presently used in inks and paints to provide various textured painted surfaces. Typically these micro size plastics are added to paint compositions which contain standard paint and coating ingredients including pigments and colorants of various colors. The pigments and colorants impart particular color to the paint. The purpose of the inclusion of the micro plastic ingredients is merely to add the quality of texture to the dried paint film. The texture is dependent upon the particle sizes of the micro plastic ingredients. The paint color is dependent upon the pigments or colorants included in the paint.

Colorants may be added to paints during the manufacture of the paint. Typically, colored pigments are ground into the paint formulation during the manufacture of the paint. The final color may be adjusted through the addition of shading paste. In the alternative, paints may be manufactured in a limited number of neutral colors. The neutral colored base paints may be colored after manufacture and prior to use by the addition of colorants. The colored paints, either as manufactured or tinted, are opaque and generally of a single color throughout the finished paint. In order to maintain the color consistency before and during the paint application, the paint must be shaken and/or stirred in order to keep the pigments and colorants uniformly suspended throughout the paint.

Liquid paints may be applied by brush, roller or spray apparatus. There are also paints which are filled into aerosol cans for spray application. These aerosol spray paints are dispensed through a spray tip device upon depression of the spray tip. The paint is evacuated from the aerosol can due to internal pressure resulting from the inclusion of a propellant at the time of filling of the aerosol spray paints. Aerosol spray paints have been marketed since the early 1960's and are in common use for small project painting and specialty application, such as inverted spray applications.

Paints may be formulated with different polymer binders or resins. Paint resins are selected based on the recommended use of the paint. Acrylic resins typically are used in water-based paints and perform general protection. Alkyd resins, which cross link during the curing process, form a denser protective paint film. Whereas, paints containing epoxy resins or polyurethane resins are generally two component, high performance coatings.

Paints of the present invention may be brush, roller or spray applied; may be used in aerosol spray paint; and may include any of various resin types commonly used in paint and coating products.

### SUMMARY OF THE INVENTION

Paint products of the present invention utilize different colored micro plastic particles of different sizes to provide coverage and individual points of specific color to the substrate being coated. Unlike other conventional paints, pigments and shading pastes need not be used as colorants in coatings of this invention. Micro plastic particles of different sizes are used to impart a multi-colored textured appearance to the dried paint film. For example, you may use a combination of dark blue small size plastic particles and lighter blue large size particles to get a multi-colored appearance of the dried paint film. The unique multi-tone appearance results from the complete randomization of particle colors and sizes upon application of the paint to a substrate. This random dispersion of micro plastic particles is made possible by the stabilization of the particle distribution achieved by the rheology engineered into the paint.

Paint products of the present invention include suspending agents. A wide variety of suspending agents are used in the paint manufacturing industry. Preferred suspending agents useful in paints of the present invention include organo clays and small particle size talcs. The combination of special organo clay and talc or other suspending agents gives the product proper rheology. Calcium carbonate or other inert pigments may be substituted for talcs if desired. The good rheology keeps the micro plastic particles suspended and allows the paint to be applied in a uniform manner. Unlike ordinary paints, paints of the present invention do not require continuous shaking and/or mixing. The micro plastic particles stay suspended in the paint solution.

The dried paint film has a satin finish and is very durable. A range of glosses is also achievable. When tested in salt fog laboratory tests, the paints of this invention showed better rust prevention than typical aerosol spray paints. Paint products of the present invention also tested very well in accelerated QUV laboratory testing.

Although there is a broad range of micro plastic particle sizes useful in paints of the present invention, the particle size is a limitation for aerosol spray paints of the present invention. For paints containing particles greater in size than 200 microns, the use of standard size aerosol spray apparatus will tend to get clogged. Special spray valves and tips will have to be used for larger size particles.

### DETAILED DESCRIPTION OF THE INVENTION

Micro plastic particles are very durable and have excellent resistance to solvents, additives and resins commonly used in paints. Polypropylene and polyethylene micro powders can be included in solvent-based coatings such as alkyds, acrylics and lacquers and high performance coatings utilizing resins such as polyurethane and epoxy. These micro plastic particles are also stable in water-based paints.

Polypropylene and polyethylene micro powders are similar to each other in performance when included in paint formulations. Both have excellent color retention and stability when exposed to ultraviolet light. In general though, polypropylene is more durable and has better abrasive resistance when compared to polyethylene.

Paint formulas of this invention include thickeners and rheology modifiers commonly used in the paint manufacturing industry. One such thickening agent is organo clay. Organo clays are mined from the earth and are known as bentonite clays. These thickeners are well known and commonly used in the manufacture of paints. They give the paint body and sag resistance.

Organo clays have been designed to work in aliphatic, aromatic and polar solvents. The surface of the bentonite is treated with different types of carbon based functional groups, which makes them compatible in different types of solvents. The organo clays used in paints of the present invention work well in all types of solvents. In particular, Tixogel@ MP250 produced by Sud-Chemie was found to be an excellent thickener for use in paints of the present invention. Additional thickeners useful in paints of the present invention include silicas, calcium carbonate and polyamides.

Talcs may also be used in paints of the present invention to modify the rheology of the paint. Talc adds to the thickening of the paint. Talcs of very small particle size are used because they are very fluffy and have high oil absorption. Small size hydrous magnesium silicate minerals, commonly known as industrial talcs are particularly useful thickening agents. Commercially available talcs which can be used in the present invention include Vantalc 6H by R.T. Vanderbilt Company and Microtalc MP 12-50 by Barrett's Mineral Company.

The present invention will be better understood by references to the following examples. Example 1 represents a solvent based concentrate useful for aerosol application when included with the proper propellant. The Colored Micro Powder 80 or 80 Mesh polypropylene ingredients have maximum particle sizes of 180 microns and the Colored Micro Powder 100 or 100 Mesh polypropylene ingredients have maximum particle sizes of 150 microns. These examples are provided for the purposes of illustration only and are not to be construed as limiting the scope of the present invention.

### Example 1

| Ingredient Name | Weight % |
|---|---|
| Alkyd resin (72% wt. solids in n-butyl acetate) | 30.5 |
| Acetone | 31.4 |
| Magnesium Silicate Hydrate-Talc | 10.1 |
| Xylene | 10.1 |
| Colored Micro Powder 80 | 4.3 |
| Colored Micro Powder 100 | 4.3 |
| Toluene | 4.1 |
| N-Butyl Acetate | 2.1 |
| Ethylene Glycol Monobutyl Ether | 1.4 |
| Tixogel MP 250 | 1.1 |
| Multisource 6% Calcium Drier | 0.2 |
| 18% Zirconium Drier | 0.2 |
| Soya Lecithin Dispersant | 0.2 |
| MEKO S/B Antiskin agent | 0.1 |
| 12% Cobalt Alkanoate Drier | 0.1 |

The alkyd resin used in Example 1 was EPS 6410 manufactured by EPS, Inc., but any alkyd resin suitable for use in aerosol spray paints may be used. There are two different size micro powders used in the example, each a different color. The different size micro powders were added in equal quantities. One micro powder polypropylene ingredient was at a maximum size of 150 microns and the other was at a maximum size of 180 microns. The colors, amounts and sizes of the micro powders may be varied to develop different aesthetic and/or performance qualities of the paint. The micro powder polypropylene used in the example was manufactured and supplied by Micro Powers, Inc.

The paint concentrate of this example is generally manufactured by standard paint manufacturing processes well known in the paint industry. However, the micro powders should be added after the high speed dispersing of the other ingredients to avoid deforming the individual plastic particles. The micro powders should be blended in the concentrate after the other ingredients have been dispersed by high speed mixing.

The paint concentrate in Example 1 is manufactured for use in an aerosol spray application. The propellants used are typically mixtures of propane and isobutane, commonly used in the manufacture of aerosol spray paint. Similar alkyd paints can be manufactured through ordinary paint manufacturing processes without the addition of propellants to develop brush paints.

As noted above, paints of this invention include water-based paints as well as high performance polyurethane and epoxy coatings. Example 2 represents a water-based concentrate useful for aerosol application when included with the proper propellant. The propellant used with the Example 2 concentrate was dimethyl ether.

### Example 2

| Ingredient Name | Weight % |
|---|---|
| Polyurethane Dispersion | 28.2 |
| Acrylic Latex | 14.4 |
| Water | 32.9 |
| 2-Butoxy ethanol | 9.0 |
| Colored Micro Powder 80 | 4.5 |
| Colored Micro Powder 100 | 4.5 |
| Isopropanol | 4.5 |
| Surfactant (Surfynol ethylene 104DPM) | 0.9 |
| Thickener (Cognis DSX-1514) | 0.4 |
| Silicone Defoamer (Tego 822) | 0.3 |
| Silicone Surfactant (BYK 346) | 0.3 |

Examples 1 and 2 teach products having two different size plastics with defined sizes. The following Examples 3, 4 and 5 teach different product formulas and manufacturing processes of specific coatings having different characteristics. They illustrate the unique manufacturing process wherein the micro plastic particles are added after the high speed dispersion process.

Example 3, Autumn Brown, illustrates the use of fine brown and black 100 mesh polypropylene to provide the base color, and the larger 80 mesh polypropylene yellow and red colors that provide the accent colors.

### Example 3

### Autumn Brown

Load high speed disperser with:

| | | |
|---|---|---|
| Xylol | 103.6 | gallons |
| 65% Solids chain-stopped alkyd | 1232 | gallons |
| Glycol ether EB | 65 | gallons |
| Bentonite clay | 381.5 | pounds |
| Lecithin | 74.2 | pounds |
| Talc | 3508.5 | pounds |

Disperse to 6–7 Hegman on high speed. Transfer to thinning tank. Add to
disperser, running at low speed.

| | | |
|---|---|---|
| Xylol | 321.5 | gallons |
| n-Butyl acetate | 720.5 | pounds |
| 100 Mesh size black polypropylene | 1266 | pounds |
| 80 Mesh size red polypropylene | 168.8 | pounds |
| 100 Mesh size brown polypropylene | 844 | pounds |
| 80 Mesh size yellow polypropylene | 760 | pounds |

Mix just until uniform, then transfer to thinning tank.
Flush the disperser

| | | |
|---|---|---|
| Xylol | 43 | gallons |
| Toluene | 202 | gallons |

Add to thinning tank under agitation

| | | |
|---|---|---|
| Methyl ethyl ketoxime | 86.7 | pounds |
| 12% Cobalt alkanoate | 50.4 | pounds |
| 6% Calcium alkanoate | 82 | pounds |
| 18% Zirconium alkanoate | 82 | gallons |
| Acetone | 1678 | gallons |
| Total | 4342.5 | gallons |

Fill into aerosol cans 75.5% paint and 24.5% propellant.

Example 4 illustrates the use of color pigments to tint the base formulation containing the polypropylene.

### Example 4

### Caribbean Sand

Load high speed disperser with

| | | |
|---|---|---|
| Xylol | 53 | gallons |
| 65% Solids chain stopped alkyd | 564 | gallons |
| Bentonite clay | 174.3 | pounds |
| Lechithin | 34 | pounds |
| Glycol ether EB | 30 | gallons |
| Talc | 1600 | pounds |

Disperse to 6–7 Hegman on high speed then transfer to thinning tank.
Re-load disperser and run on low speed.

| | | |
|---|---|---|
| Xylol | 166 | gallons |
| n-Butyl acetate | 330 | pounds |
| 80 Mesh size white polypropylene | 1267.7 | pounds |
| 80 Mesh size mocha polypropylene | 50 | pounds |
| 80 Mesh size black polypropylene | 50 | pounds |

Mix on low speed until just homogeneous. Transfer to thinning tank.
Flush dispenser

| | | |
|---|---|---|
| Toluene | 92.5 | gallons |

Add to thinning tank under mild agitation

| | | |
|---|---|---|
| 12% Cobalt alkanoate | 23.1 | pounds |
| 6% Calcium alkanoate | 37.5 | pounds |
| 18% Zirconium alkanoate | 37.5 | pounds |
| Methyl ethyl ketoxime | 40 | pounds |
| 60% Pigment TiO2 acrylic dispersion | 155.5 | pounds |

Hold for color/appearance adjustment

| | | |
|---|---|---|
| 80 Mesh size mocha polypropylene | 7.6 | pounds |
| 80 mesh size black polypropylene | 7.6 | pounds |
| 60% Pigment TiO2 acrylic dispersion | 75 | pounds |

Add to thinning tank just prior to filling into aerosol cans.

| | | |
|---|---|---|
| Acetone | 767 | gallons |
| Total | 1999.7 | gallons |

Fill into aerosol cans 75.5% paint, 24.5% A-85 propellant.

Example 5 illustrates the use of color pigments and metallic flake to color the base formulation containing the polypropylene.

### Example 5

### Radiant Brass

Load high speed disperser

| | | |
|---|---|---|
| Xylol | 53 | gallons |
| 65% solids chain stopped alkyd | 549 | gallons |
| Bentonite clay | 172.7 | pounds |
| Lecithin | 33.6 | pounds |
| Glycol ether EB | 29.5 | gallons |
| Talc | 1592 | pounds |

Disperse on high speed to 6–7 Hegman, then transfer to thinning tank.
Reload disperser on low speed

| | | |
|---|---|---|
| Xylol | 149 | gallons |
| n-Butyl acetate | 327 | pounds |
| 80 Mesh size black polypropylene | 454 | pounds |
| 80 Mesh size orange polypropylene | 75.6 | pounds |
| 80 Mesh size yellow polypropylene | 75.6 | pounds |

Mix on low speed until just uniform, then transfer to thinning tank.
Rinse disperser.

| | | |
|---|---|---|
| Toluene | 91.5 | gallons |

Add to thinning tank with agitation.

| | | |
|---|---|---|
| 12% Cobalt alkanoate | 22.9 | pounds |
| 6% Calcium alkanoate | 37.2 | pounds |
| 18% Zirconium alkanoate | 37.2 | pounds |
| Transparent yellow oxide dispersion | 53.5 | pounds |
| Transparent red oxide dispersion | 53.5 | pounds |

Mix in a tub to a smooth paste, then add to thinning tank with agitation.

| | | |
|---|---|---|
| 65% Solids chain stopped alkyd | 10 | gallons |
| Non-leafing aluminum flakes | 381.6 | pounds |
| Xylol | 5 | gallons |

Rinse tub

| | | |
|---|---|---|
| Xylol | 10 | gallons |

Hold for color/appearance adjustment.

| | | |
|---|---|---|
| Transparent yellow oxide dispersion | 10 | pounds |
| Transparent red oxide dispersion | 10 | pounds |

Add to thinning tank just before filling into aerosol cans.

| | | |
|---|---|---|
| Acetone | 845 | gallons |
| Total | 2000 | gallons |

Fill into aerosol cans 75.5% paint, 24.5% A-85 propellant.

1. A paint product comprising: (a) polymer waxes such as polypropylene or polyethylene plastics which have been ground to particle sizes ranging from 44 microns to 840 microns, wherein said polymer waxes are of different sizes and/or different colors, except that they may not consist solely of black and/or white pigmented polymer waxes; and (b) suspending agents such as, but not limited to, organo clays, small particle size talcs, calcium carbonate and other inert pigments commonly used as suspending agents in paint compositions.

2. A paint product of claim 1 wherein there are no colored pigments, shading pastes, or dyes included, the only colorants consisting of colored polymer waxes.

3. A paint product of claim 1 wherein there are both colored pigments and colored polymer waxes.

4. An aerosol paint product comprising: (a) polymer waxes such as polypropylene or polyethylene plastics which have been ground to particle sizes ranging from 44 microns to 200 microns, wherein said polymer waxes are of different sizes and/or different colors, except that they may not consist solely of black and/or white pigmented polymer waxes; (b) suspending agents such as, but not limited to, organo clays, small particle size talcs, calcium carbonate and other inert pigments commonly used as suspending agents in paint compositions; and (c) propellant.

5. An aerosol paint product of claim 4 wherein the resin is an alkyd resin and the propellant comprises a mixture of propylene and isobutane.

6. An aerosol paint product of claim 4 wherein the resin is an acrylic and/or water soluble alkyd and the propellant is dimethyl ether.

7. A process for the manufacture of paint products comprising: (a) polymer waxes such as polypropylene or polyethylene plastics which have been ground to particle sizes ranging from 44 microns to 840 microns; and (b) suspending agents such as, but not limited to, organo clays, small particle size talcs, calcium carbonate and other inert pigments commonly used as suspending agents in paint compositions, wherein the resins and suspending agents are first mixed in a high speed disperser and the polymer waxes are then loaded in the paint solution and mixed at low speeds.
